(19) United States
(12) Patent Application Publication
(10) Pub. No.: US 2020/0324794 A1
(43) Pub. Date: Oct. 15, 2020

(54) TECHNOLOGY TO APPLY DRIVING NORMS FOR AUTOMATED VEHICLE BEHAVIOR PREDICTION

(71) Applicant: Intel Corporation, Santa Clara, CA (US)

(72) Inventors: Guixiang Ma, Hillsboro, OR (US); Nicole Beckage, Beaverton, OR (US); Nesreen Ahmed, Santa Clara, CA (US); Ignacio Alvarez, Portland, OR (US)

(21) Appl. No.: 16/912,241

(22) Filed: Jun. 25, 2020

(51) Int. Cl. B60W 60/00; G06N 3/04; G06N 3/08; G06F 16/28; G06F 16/29

(52) U.S. Cl. CPC B60W 60/00272; B60W 60/0011; G06N 3/0454; B60W 2050/0089; G06F 16/284; G06F 16/29; G06N 3/08

(57) ABSTRACT

Systems, apparatuses and methods may provide for technology that generates a series of time-stamped object graphs based on object trajectory histories derived from external object data for a plurality of external objects, such as vehicles. The technology may also generate, via a first neural network such as a graph attention network, a series of relational object representations based on the series of time-stamped object graphs, and determine, via a second neural network such as a long short-term memory network, predicted object trajectories for the plurality of external objects based on the series of relational object representations. The technology may also modify behavior of an autonomous vehicle based on the predicted object trajectories and real-time perceptual error information.

### TECHNICAL FIELD

Embodiments generally relate to automated control systems. More particularly, embodiments relate to technology that learns and applies driving norms in automated vehicle control systems.

### BACKGROUND

Automated control systems may be used in a variety of environments such as, for example, autonomous vehicle environments. Driving a vehicle often requires the interpretation of subtle indirect cues to predict the behavior of other traffic agents. These cues are often relational. Given that the set of allowed (safe) actions a vehicle can execute are limited by the driving agent's ability to communicate, drivers often rely on local driving norms and expected behavior using reasoning and predictability to operate efficiently and safely. The ability to implicitly or explicitly communicate cues helps assure safe driving conditions. While direct interaction between objects in a driving setting poses clear danger, indirect interactions between vehicles and other objects along the road can increase the safety and interpretability of vehicle actions. Drivers gain a considerable amount of information about nearby vehicles based on the adherence of the vehicles (and drivers) to normative driving behavior. For example, indirect interactions between vehicles may communicate the desire to switch lanes, upcoming traffic delays, and more.

Communications between vehicles or between a pedestrian and vehicle is inherently relational as the two agents must exchange information using an agreed upon vocabulary. Deviations from driving norms may present safety challenges for autonomous (i.e., self-driving) vehicles in mixed traffic environments.

### BRIEF DESCRIPTION OF THE DRAWINGS

The various advantages of the embodiments will become apparent to one skilled in the art by reading the following specification and appended claims, and by referencing the following drawings, in which:

FIG. 1 is a diagram illustrating components of an example of an autonomous vehicle system according to one or more embodiments;

FIG. 2 is a block diagram of an example of a relational reasoning system for an autonomous vehicle according to one or more embodiments;

FIG. 3 is a diagram illustrating an example of a graph extraction module of a relational reasoning system according to one or more embodiments;

FIG. 4 is a diagram illustrating an example of a graph attention network of a relational reasoning system according to one or more embodiments;

FIG. 5 is a diagram illustrating an example of a long short-term memory network of a relational reasoning system according to one or more embodiments;

FIG. 6 provides a flowchart illustrating operation of an example of a relational reasoning system for an autonomous vehicle according to one or more embodiments;

FIG. 7 is a block diagram illustrating an example of a performance-enhanced computing system according to one or more embodiments;

FIG. 8 is a block diagram illustrating an example semiconductor apparatus according to one or more embodiments;

FIG. 9 is a block diagram illustrating an example of a processor according to one or more embodiments; and

FIG. 10 is a block diagram illustrating an example of a multiprocessor-based computing system according to one or more embodiments.

### DESCRIPTION OF EMBODIMENTS

In general, embodiments provide a relational reasoning system for an autonomous vehicle that predicts behaviors of traffic participants in a driving environment. Embodiments also provide for efficient prediction of traffic-agents future trajectories and quantification of deviation between observed behavior to predicted behavior for trajectory planning and safety calculations. Additionally, embodiments include technology that will capitalize on relational information and be trained to encode knowledge of driving norms. More particularly, embodiments use a graph attention network to learn relational embeddings which are then fed to a recurrent neural network. The recurrent neural network provides trajectory predictions for an autonomous vehicle as well as for neighboring vehicles and objects, and detects potential collisions.

Embodiments of the relational reasoning system provide autonomous vehicles with the capability of learning and reasoning about regional and local driving behavior to predict intent and improve communication between cars on the road and communication between other individuals such as bikers and pedestrians. Relational communication between agents in a transportation setting relies heavily on adherence to predictable and agreed upon action/responses which can be considered local driving norms. The agent must not only recognize a behavior but also decide if a specific action is communicative. After deciding that an action is meant to communicate an intent, the driving agent must then provide an interpretation for the intent. The same actions in different geographical region and contextual situation might communicate many different things. According to embodiments, the system may quickly generalize to new situations and new locations which have a unique set of norms.

For example, most of the underlying reasoning that supports autonomous vehicles (i.e., self-driving cars) focuses on recognition and trajectory predictions of objects within a particular safety-radius of the self-driving car. While this has been shown to guarantee certain levels of safety, it neglects many of the types of relational information that could also be used to increase safety and predictability of a self-driving system. In the case of indirect communication between two agents, relational information becomes more important than object level information, and communication between drivers is important to road safety. Embodiments use neural network embeddings to learn relational information which can be used for various types of relational reasoning related to self-driving cars, with focus on safety decisions and verification of self-driving cars in terms of extending object detection to infer trajectories of recognized objects and to detect possible collisions, and the resulting implications of collisions or avoidances on the environment. Such embodiments not only detect objects in the scene, but also reason about how these objects will interact within a constantly changing environment. Additionally, to decrease ambiguity and to increase the amount of computational reasoning a self-driving car can accomplish, embodiments represent normative driving behavior and compare possible indirect communication to normative behavior, by identifying meaningful interactions, considering normative interactions in the specific situation, and comparing the potential deviance from normative behavior to behavioral intent.

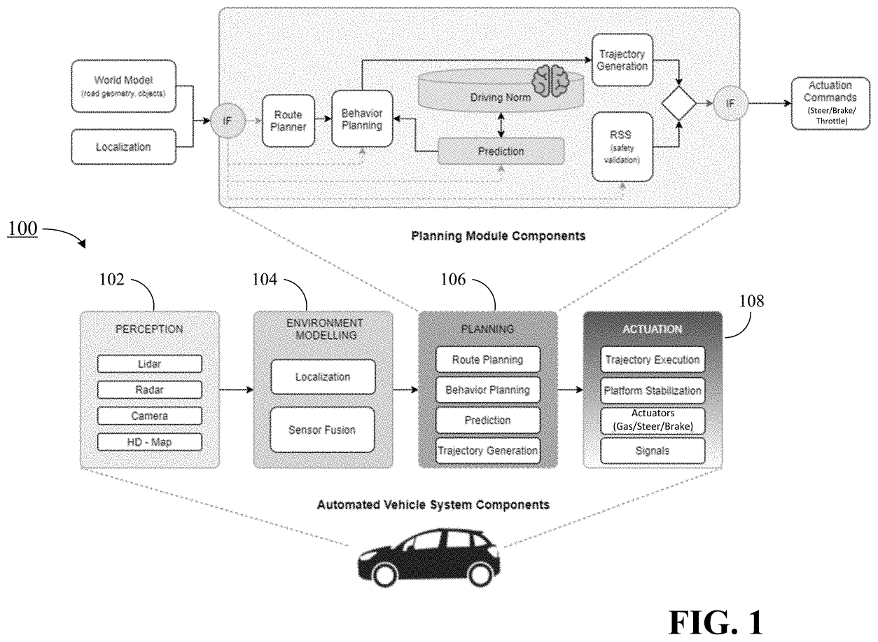

FIG. 1 is a diagram illustrating components of an example of an autonomous vehicle system 100 according to one or more embodiments, with reference to components and features described herein including but not limited to the figures and associated description. The autonomous vehicle system 100 may include several modules or subsystems, including a perception module 102, an environmental module 104, a planning module 106 and an actuation module 108. The perception module 102 and the environmental module 104 may collect perceptual features via sensors (e.g. lidar, radar, camera, and location information) and process them to get localization and kinematic information pertaining to relevant agents and objects in the ego vehicle's environment.

This information may be provided as input to the planning module 106, which may carry out features of the relational reasoning system described in more detail in the following figures. In some embodiments, the planning module 106 may include some or all of components as shown in the breakout illustration in FIG. 1. The output of planning module 106 may be provided as input to the actuation module 108, which may carry out actuation commands for controlling steering, acceleration, and/or braking functions of the autonomous vehicle.

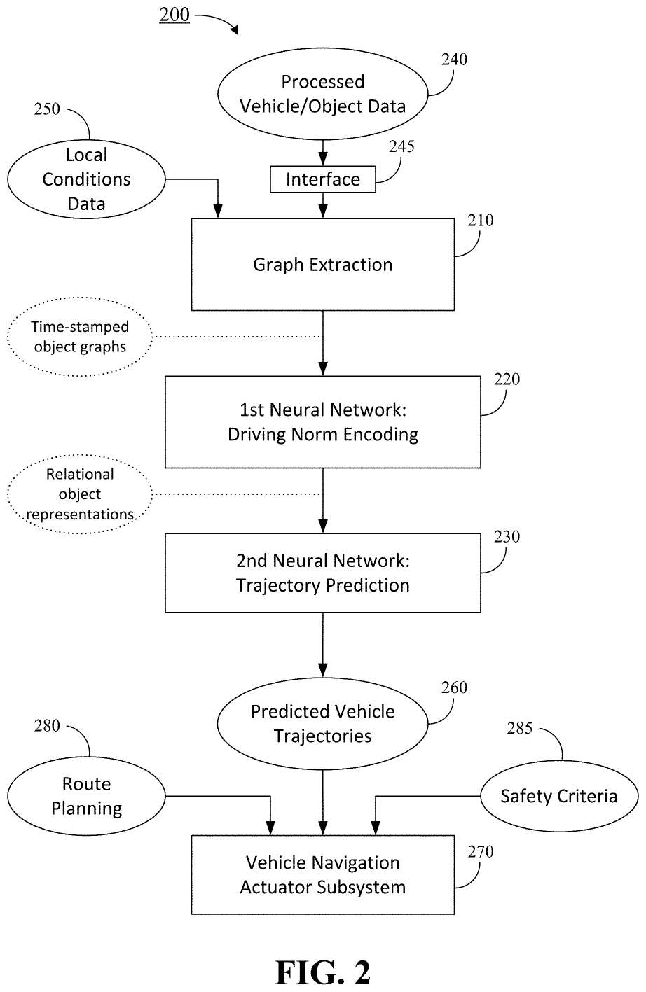

FIG. 2 is a block diagram of an example of a relational reasoning system 200 for an autonomous vehicle according to one or more embodiments, with reference to components and features described herein including but not limited to the figures and associated description. Embodiments provide a framework (i.e., subsystem), based on two neural networks, which receives as input processed perceptual features (including, e.g., localization and kinematic information) providing trajectory histories pertaining to the ego vehicle along with other vehicles and objects. The trajectory histories may be converted to graphs by a graph extraction module and fed to a first neural network for driving norm encoding, which in turn may be fed to a second neural network for trajectory prediction. The trajectory prediction may be used to inform actuation commands. The first neural network may be a graph attention (GAT) network to encode driving norms and agent to agent communication with the spatial and temporal information from the driving scene in a relational model. This relational representation may then be provided to the second neural network, which may be a long short-term memory (LSTM) recurrent network, to predict the trajectories of the autonomous vehicle and interacting objects. The GAT-LSTM framework may receive training feedback comparing the predicted to actual trajectories of specific objects interacting within the scope of the autonomous vehicle system. In embodiments, the graph extraction module may be implemented in software executing in a processor, and the GAT and LSTM networks may be implemented in a field programmable gate array (FPGA) accelerator. In this manner, the main part of the model (i.e., the GAT-LSTM) can be trained efficiently in the FPGA, while performing the graph extraction module in the processor can reduce the memory access requirements and the computation to be performed otherwise in the FPGA. In an embodiment, the GAT and LSTM networks may be implemented in a combination of a processor and a FPGA.

During inference, this framework may predict future trajectories and evaluate deviation between predicted trajectories and observed trajectories. The predicted trajectories may include real-time perceptual error information in the calculation of each trajectory, influencing the navigation behavior of the autonomous vehicle. In some embodiments, the predicted trajectories as well as real-time perceptual error information may be paired with safety criteria to provide driving behavior constraints.

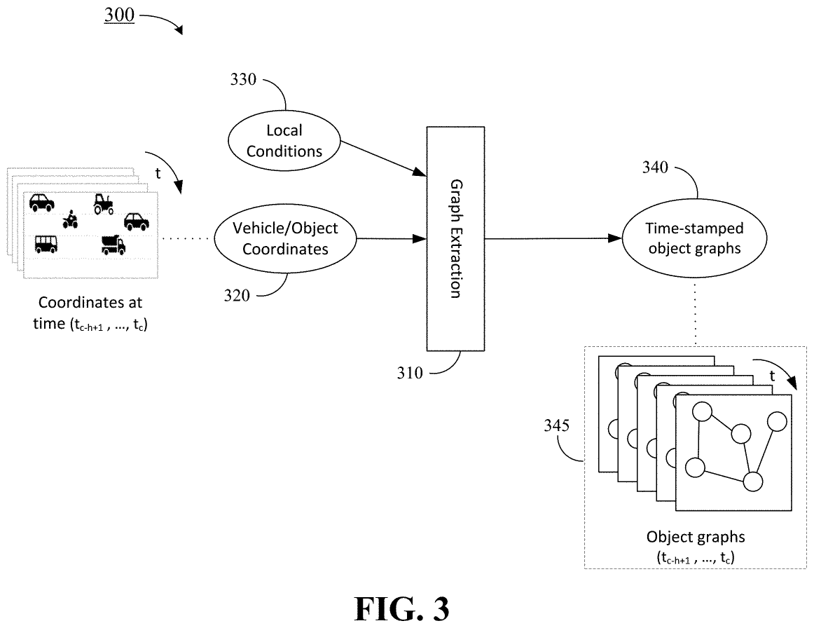

As shown in FIG. 2, a relational reasoning system 200 may include a framework comprising a graph extraction module 210, a first neural network 220, and a second neural network 230. The graph extraction module 210, as further described with reference to FIG. 3 herein, may generate a series of time-stamped object graphs based on input processed vehicle and object data 240. The input processed vehicle and object data 240 may be obtained from sensor data (such as, for example, cameras, radar, lidar, etc.), map data, and other data providing information about vehicles and other objects in the vicinity of the ego vehicle, and may be received via a sensor interface 245. In some embodiments, the input processed vehicle and object data 240 may be obtained from a perception module (e.g., via perception module 102 and/or environmental module 104 as shown in FIG. 1, already discussed). The perception module may be, e.g., a perception module such as one used in conjunction with the Responsibility-Sensitive Safety (RSS) mathematical framework, introduced by Intel© and Mobileye, for autonomous vehicle operation. Additional data such as indirect interactions between vehicles (e.g., flashing headlights) or between vehicle/pedestrian/biker (e.g., manual turn signal) and other indicators (e.g., turn signals, brake lights, horns, emergency vehicle lights or sirens) may also be included in the input vehicle and object data 240. In an embodiment, local conditions data 250 may also be input to the graph extraction module 210 and encompassed, along with the processed vehicle and object data, in the generated time-stamped object graphs. The local conditions data 250 may include, for example, one or more of weather conditions, time of day, day of week, day of year, fixed obstacles, etc.

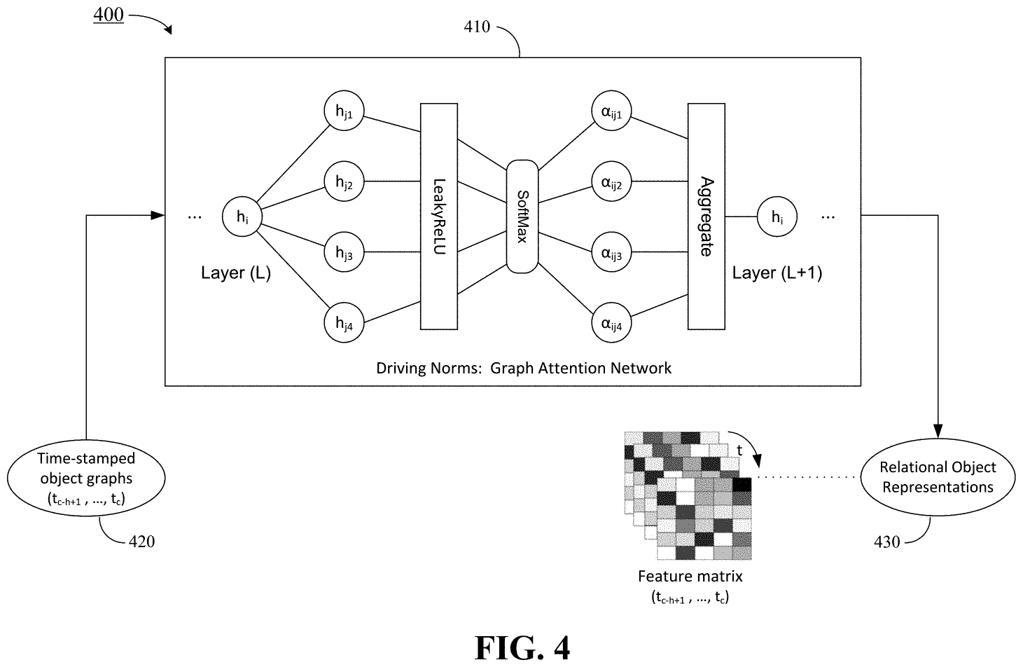

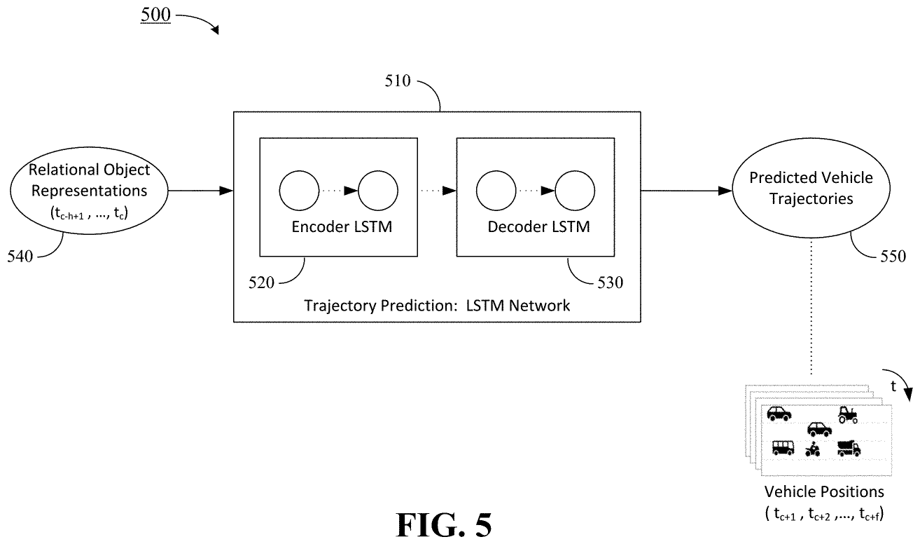

The first neural network 220, which may be a graph attention (GAT) network as further described with reference to FIG. 4 herein, may receive as input the series of time-stamped object graphs, and learns embeddings that embrace driving norms to generate a series of relational object representations. The second neural network 230, which may be a long short-term memory (LSTM) recurrent network as further described with reference to FIG. 5 herein, may receive as input the series of relational object representations to determine predicted object trajectories for the ego vehicle and other external objects (including other vehicles). By combining a graph attention network to learn relational and spatial interactions among traffic agents with a long short-term memory network to learn longer term changes and dependencies of each traffic agent through recurrence, this framework leverages both the benefits of relational reasoning and that of the temporal sequence learning with neural networks targeted at encoding driving norms to improve trajectory prediction.

The predicted vehicle trajectories 260 (i.e., prediction of future trajectories of the vehicles) resulting from the second neural network 230 may be provided as input to a vehicle navigation actuator subsystem 270 for use in navigating and controlling the autonomous vehicle. Additionally, route planning input 280 from a route planning module and safety criteria input 285 from a safety module may also be applied by the vehicle navigation actuator subsystem 270 in navigating and controlling the autonomous vehicle. Information such as traffic signs, rules of the road (e.g. drive on right side of road, keep right except to pass, pass only if dashed line, etc.) may be utilized by the route planning module to influence route planning input 280.

FIG. 3 is a diagram 300 illustrating an example of a graph extraction module 310 of a relational reasoning system according to one or more embodiments, with reference to components and features described herein including but not limited to the figures and associated description. The graph extraction module 310 may generally be incorporated into the graph extraction module 210 (FIG. 2), already discussed. The graph extraction module 310 may receive as input vehicle and object coordinate data 320. The vehicle and object coordinate data 320, which may be a vector, may be determined from identified relevant objects and their locations that appeared in the sensor data (e.g., video and/or images). The vehicle and object coordinate data 320 may include, for example, coordinates for the ego vehicle and for other vehicles in the vicinity of the ego vehicle, such as, e.g., other cars, trucks, buses, motorcycles, tractors, etc. These coordinates may be measured at a series of intervals over a particular history time window {t_{c-h+1}, . . . , t_{c}}. In this regard, the vehicle and object coordinate data 320 may represent vehicle and object trajectory histories over the time window of measurement. In some embodiments, the vehicle and object coordinate data 320 may comprise input processed vehicle and object data 240 (FIG. 2), already discussed. In an embodiment, local conditions data 330, which may be a vector, may also be input to the graph extraction module 310. In an embodiment, the local conditions data 330 may comprise the local conditions data 250 (FIG. 2), already discussed.

The graph extraction module 310 may process the vehicle and object coordinate data 320 by calculating a distance dᵢⱼ for each pair of objects i and j based on their coordinate values. A graph Gₛ={Vₛ, Eₛ} may then be created for each time point s, where each node in the graph represents an object, and an edge exists between nodes i and j if dᵢⱼ<D, where D is a threshold distance. Once all of the coordinates for the history time window have been processed, the trajectory histories are converted to graphs. That is, the coordinates (object locations/images) at timesteps {t_{c-h+1}, . . . , t_{c}} are converted to time-stamped graphs {Gₜ_{_{c−h+1}}, . . . , Gₜ_{_{c}}}. Given the output collection of time-stamped object graphs 340 and the coordinate values (xᵢₛ,yᵢₛ) for each node i at each timestamp s, trajectory prediction may be based on predicting the coordinate values for the nodes at future time points {t_{c+1}, t_{c+2}, . . . , t_{c+f}}, where f is the size of the future window for which a prediction is to be obtained.

The time-stamped object graphs 340 may be visualized as a time series of two-dimensional graphs 345, where each plane represents a graph constructed for one of the particular timestamps, and each node in a graph represents an object position. Of course, as constructed the graphs may represent more than two dimensions. For example, each graph generated may encompass three dimensions (representing object position in 3-dimensional space). Graphs of additional dimensions may be generated based on additional input vectors.

FIG. 4 is a diagram 400 illustrating an example of a graph attention network 410 of a relational reasoning system according to one or more embodiments, with reference to components and features described herein including but not limited to the figures and associated description. In general terms, a graph attention network is a neural network that operates on graph-structured data, by stacking neural network layers in which nodes are able to attend to their neighborhoods' features. The graph attention network 410 may generally be incorporated into the first neural network 220 (FIG. 2), already discussed. The graph attention network 410 is designed to capture the relational interactions among the nodes in the graphs, i.e., the spatial interactions between the traffic agents, which encode information about the driving norm in that geo-location. A set of time-stamped object graphs 420 provides a set of node features (i.e., the coordinate values for each traffic agent) as input to the graph attention network 410. Each traffic agent is represented as a node in a graph and the edges denote a meaningful relationship between two agents. The relational representation will be encouraged via training on data where interactions between objects are possible and/or communicative such that the model will learn driving norms in diverse environments.

The graph attention network 410 may include a number (M) of stacked neural network layers, and each neural network feed-forward activation layer produces a new set of latent node features, also called embeddings, representing learned relational information. In addition to capturing important relational interactions among nodes, advantages of the graph attention architecture include efficiency in computation, since predictions in graphs can be parallelized and executed independently across node neighborhoods, and inductive learning, i.e., the model can generalize to new/unseen nodes, edges, and graphs.

As illustrated in FIG. 4, the node embedding for node i in layer L+1 of the graph attention network 410 may be computed from the node features or embeddings of node i and its neighboring nodes N(i) in layer L. Given the node embeddings from layer L, a shared linear transformation, parameterized by a weight matrix W, is applied to each node, and an attentional mechanism (att) is then performed on the nodes to compute the attention coefficients between node i and each neighboring node j:

eᵢⱼ=att(Whᵢ,Whⱼ)

Each value eᵢⱼ indicates the importance of node j's features to reference node i. The SoftMax function is used to normalize the attention coefficients across all choices of j:

$${α}_{ij} = {softmax}_{j} ( {e}_{ij} ) = \frac{exp ( {e}_{ij} )}{{Σ}_{k ∈ N ( i )} exp ( {e}_{ik} )} ,$$

where node k is a neighbor of node i. In the graph attention network 410, the attention mechanism att may be a single-layer feed-forward neural network, parameterized by a learnable weight vector a and applying the LeakyReLU non-linearity. The Leaky Rectified Linear Unit function (LeakyReLU) is an activation function used in neural networks. Fully expanded out, the coefficients computed by the attention mechanism can be expressed as:

$${α}_{ij} = \frac{exp ( Leaky ReLU ( {a}^{T} [ {Wh}_{i} \vert \vert {Wh}_{j} ] ) )}{{Σ}_{k ∈ {N}_{i}} exp ( LeakyReLU ( {a}^{T} [ {Wh}_{i} \vert \vert {Wh}_{k} ] ) )}$$

As shown in FIG. 4, node i has neighbors {j₁,j₂,j₃,j₄}, with their node embeddings {hⱼ_{₁},hⱼ_{₂},hⱼ_{₃},hⱼ_{₄}} from layer l. Attention coefficients {eᵢⱼ_{₁},eᵢⱼ_{₂},eᵢⱼ_{₃},eᵢⱼ_{₁}} may be computed, where eᵢⱼ_{₁}=LeakyReLU(a^{T}[Whᵢ∥Whⱼ_{₁}]). Then, after applying the SoftMax function, the normalized coefficients {αᵢⱼ_{₁},αᵢⱼ_{₂},αᵢⱼ_{₃},αᵢⱼ_{₄}}, may be computed as follows:

$${α}_{{ij}_{1}} = \frac{exp ( Leaky Re LU ( {a}^{T} [ {Wh}_{i} \vert \vert {Wh}_{{j}_{1}} ] ) )}{{Σ}_{k ϵ \{ {j}_{1} , {j}_{2} , {j}_{3} , {j}_{4} \}} exp ( Leaky ReLU ( {a}^{T} [ W {h}_{i} \vert \vert {Wh}_{k} ] ) )} ,$$

where vectors α and W may be obtained via training. To obtain the (L+1)-layer output embedding hᵢ for node i, the normalized attention coefficients {αᵢⱼ_{₁},αᵢⱼ_{₂},αᵢⱼ_{₃},αᵢⱼ_{₄}} may then be aggregated via a linear combination of the features of neighboring nodes, and a nonlinearity function σ (e.g., Rectified Linear Unit, or ReLU) may be applied:

hᵢ=σ(Z_{j∈N(i)}αᵢⱼWhⱼ)

After processing via the M layers of the graph attention network 410, a resulting set of relational object representations 430 may be obtained. The relational object representations 430 may provide a feature matrix for each time stamp in time window {t_{c-h+1}, . . . , t_{c}}, where each row represents the feature vector for a traffic agent, which has encoded the spatial and communicative interactions between this agent and its neighboring traffic agents. The relational object representations 430 represent learned relationships among the vehicles and other objects over the history time window—including how the relationships vary over the time window.

FIG. 5 is a diagram 500 illustrating an example of a long short-term memory (LSTM) neural network 510 of a relational reasoning system according to one or more embodiments, with reference to components and features described herein including but not limited to the figures and associated description. In general terms, a long short-term memory neural network is a recurrent neural network that incorporates memory cell(s) to make it less sensitive to temporal delay length as compared to other sequence learning models. Thus, in the context of the relational reasoning framework, the LSTM network 510 can process and predict time series given time lags of unknown duration and for graphs of various size and density. Together with the graph attention network 410, this enables the relational reasoning system to be highly flexible on the duration of history needed for prediction and also the future time period over which the system can predict object trajectories. The LSTM network 510 may generally be incorporated into the second neural network 230 (FIG. 2), already discussed.

The LTSM network 510 may include an encoder LSTM 520 and a decoder LSTM 530. Each of the encoder LSTM 520 and the decoder LSTM 530 may itself be a long short-term (LSTM) neural network, where the encoder LSTM is used for encoding the relational representations learned at multiple time points, and the decoder LSTM is adopted for future trajectory prediction. Each of the encoder LSTM 520 and the decoder LSTM 530 maybe a two-layer LSTM network. In some embodiments, the encoder LSTM 520 and/or the decoder LSTM 530 may include an arrangement using three or more layers; the number of layers may be determined to best accommodate the scale and complexity of the collected vehicle data. The relational object representations 540, the learned relational representations of each traffic agent at each time point together with their temporal features (i.e., information pertaining to local driving norms as output by graph attention network 410), may be received as input to the LTSM network 510 for encoding, via the encoder LSTM 520, the temporal location changes of each traffic agent or object. The hidden state of the encoder LSTM 520 and the coordinate values of each agent at the history time points may, in turn, be fed into the decoder LSTM 530 to predict the future trajectories (i.e., object behaviors) of each traffic agent or object, given by the coordinates Yₗ_{_{pred}}^{t}=(xᵢₜ,yᵢₜ) for agent i for the future f time points t={t_{c+1}, . . . , t_{c+f}}. The predicted vehicle trajectories 550 (i.e., prediction of future trajectories of the vehicles) may be output from the LSTM network 510 and utilized in connection with the autonomous vehicle actuation, e.g., the vehicle navigation actuator subsystem 270 (FIG. 2), already discussed. Prediction of object behaviors may include predicting object coordinates (position), orientation (heading) and/or speed attributes (e.g., velocity).

The relational reasoning system (specifically, the graph attention network 410 along with the LSTM network 510) may be trained using data representing a variety of situations and locations—thus making the relational reasoning system robust and capable of generalizing to changing and variable conditions with geo-location changes and local normative changes. The relational reasoning system GAT-LSTM is an end-to-end framework, and therefore the neural network components in this framework are trained together as a unit. Training data may be obtained from data recordings such as the ones captured in today's automated vehicle fleets. For example, the input to the relational reasoning system may be the output of a perception module at particular times, and the system would be trained based on the accurate prediction of sequential trajectories given the input data. For training purposes, a loss function may be employed to measure error. An error function used to train the system may be based on predicting the future trajectories of traffic agents represented in the training data. As an example, the following mean squared error (MSE) loss function may be used in training the relational reasoning system:

$$Loss = \frac{1}{f * N} {Σ}_{t = {t}_{c + 1}}^{{t}_{c + f}} {Σ}_{i = 1}^{N} {‖ {Y}_{{i}_{p r e d}}^{t} - {Y}_{{i}_{t r u e}}^{T} ‖}^{2} ,$$

where t={t_{c+1}, t_{c+2} . . . , t_{c+f}} is the time point in the future, Yᵢ_{_{pred}}^{t} is the predicted coordinate for traffic agent i at time t, and Yᵢ_{ₜᵣᵤₑ}^{t} is the ground truth (true coordinate for agent i at time t). The relational reasoning system may be trained using a stochastic gradient descent optimizer such as, e.g., the stochastic gradient descent optimizer described in Kingma, Diederik P., and Jimmy Ba, “Adam: A method for stochastic optimization,” available via arXiv preprint: arXiv:1412.6980 (2014).

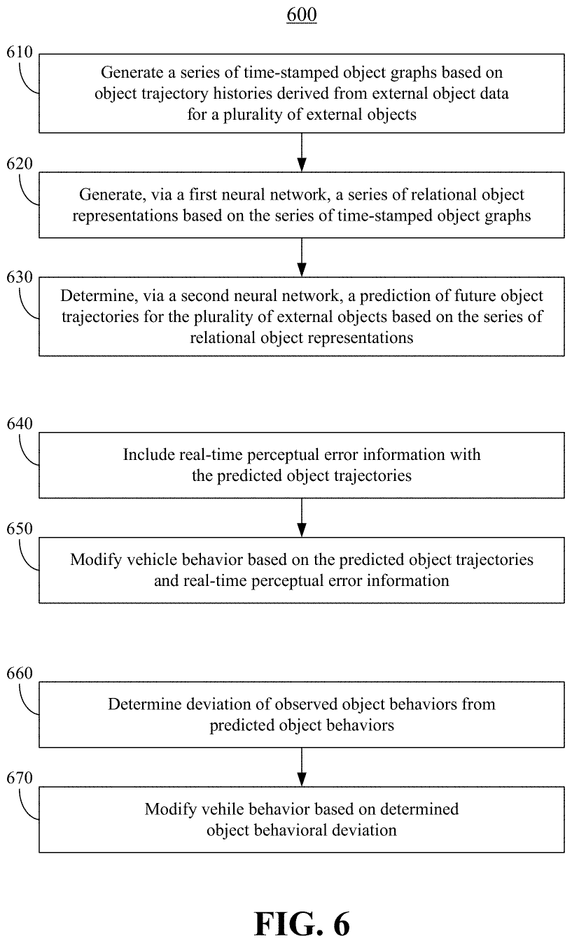

FIG. 6 provides a flowchart illustrating a process 600 for operating an example of a relational reasoning system for an autonomous vehicle according to one or more embodiments, with reference to components and features described herein including but not limited to the figures and associated description. Process 600 may be implemented in relational reasoning system 200 described herein with reference to FIG. 2, already discussed. More particularly, the process 600 may be implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in process 600 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 610 provides for generating a series of time-stamped object graphs based on object trajectory histories derived from external object data for a plurality of external objects. The external object data may include the vehicle and processed vehicle and object data 240 (FIG. 2) or the object coordinate data 320 (FIG. 3), already discussed. The series of time-stamped object graphs based on object trajectory histories may be generated via the graph extraction module 310 (FIG. 3), already discussed, and may include the time-stamped object graphs 340 (FIG. 3), already discussed.

Illustrated processing block 620 provides for generating, via a first neural network, a series of relational object representations based on the series of time-stamped object graphs. The first neural network may include the neural network 220 (FIG. 2) or the graph attention network 410 (FIG. 4), already discussed. The series of relational object representations may include the relational object representations 430, already discussed.

Illustrated processing block 630 provides for determining, via a second neural network, a prediction of future object trajectories for the plurality of external objects based on the series of relational object representations. The second neural network may include the neural network 230 (FIG. 2) or the LSTM network 510 (FIG. 5), already discussed. The prediction of future object trajectories for the plurality of external objects may include the predicted vehicle trajectories 260 (FIG. 2) or the predicted vehicle trajectories 550 (FIG. 5), already discussed.

The predicted object trajectories for the plurality of external objects (block 630) may be used by an autonomous vehicle for navigation purposes. For example, illustrated processing block 640 provides for including real-time perceptual error information with the predicted object trajectories. Next, illustrated processing block 650 provides for modifying the vehicle behavior based on the predicted object trajectories and real-time perceptual error information. Modifying vehicle behavior may include issuing actuation commands to navigate the vehicle. Actuation commands may be different depending on the low-level controller of the vehicle. In general, the low-level controller is given a reference target speed and a path composed of a sequence of points in the vehicle reference frame that the controller seeks to adhere to. That is, the controller sets the steering wheel and throttle/brake to maintain that target speed while going to the next points that compose the path. In some embodiments, actuation commands may include values for throttle, braking and steering angle.

In some embodiments, the predicted trajectories as well as real-time perceptual error information may be paired with safety criteria to provide driving behavior constraints. Safety criteria may generally be understood to include rules or guidelines for collision avoidance, for example by establishing a minimum longitudinal and lateral distance metric during a particular situation. Safety criteria may also include local rules of the road such as maximum speed in the road segment, respecting signals, and/or allowing—or prohibiting—certain manoeuvres (e.g., at intersections). To help ensure safety, the predicted object trajectories for the plurality of external objects (block 630) may also be used by an autonomous vehicle to modify or constrain vehicle behavior even more than provided by safety criteria. For example, illustrated processing block 660 provides for determining the deviation of observed object behaviors from predicted object behaviors. Next, illustrated processing block 670 provides for modifying the vehicle behavior based on the determined deviation of object behavior from predicted behavior. Examples of modifying the ego vehicle behavior may include: 1) increasing longitudinal distance to another vehicle in the same lane and direction, 2) increasing minimum lateral distance to a road user in an adjacent lane, 3) giving way to another vehicle at an intersection (even if the ego vehicle has priority or right-of-way, 4) reducing current speed (e.g., in areas with occlusion or other obstacles) even if speed is within the maximum speed allowed for the current road segment.

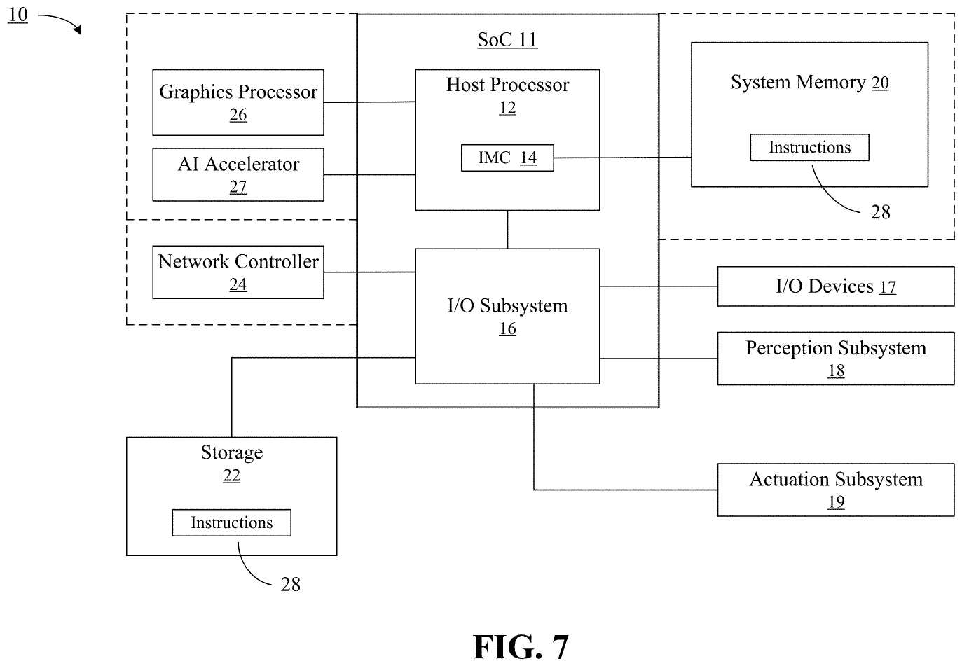

FIG. 7 shows a block diagram illustrating an example computing system 10 for predicting vehicle trajectories based on local driving norms according to one or more embodiments, with reference to components and features described herein including but not limited to the figures and associated description. The system 10 may generally be part of an electronic device/platform having computing and/or communications functionality (e.g., server, cloud infrastructure controller, database controller, notebook computer, desktop computer, personal digital assistant/PDA, tablet computer, convertible tablet, smart phone, etc.), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, etc., or any combination thereof. In the illustrated example, the system 10 may include a host processor 12 (e.g., central processing unit/CPU) having an integrated memory controller (IMC) 14 that may be coupled to system memory 20. The host processor 12 may include any type of processing device, such as, e.g., microcontroller, microprocessor, RISC processor, ASIC, etc., along with associated processing modules or circuitry. The system memory 20 may include any non-transitory machine- or computer-readable storage medium such as RAM, ROM, PROM, EEPROM, firmware, flash memory, etc., configurable logic such as, for example, PLAs, FPGAs, CPLDs, fixed-functionality hardware logic using circuit technology such as, for example, ASIC, CMOS or TTL technology, or any combination thereof suitable for storing instructions 28.

The system 10 may also include an input/output (I/O) subsystem 16. The IO subsystem 16 may communicate with for example, one or more input/output (I/O) devices 17, a network controller 24 (e.g., wired and/or wireless NIC), and storage 22. The storage 22 may be comprised of any appropriate non-transitory machine- or computer-readable memory type (e.g., flash memory, DRAM, SRAM (static random access memory), solid state drive (SSD), hard disk drive (HDD), optical disk, etc.). The storage 22 may include mass storage. In some embodiments, the host processor 12 and/or the I/O subsystem 16 may communicate with the storage 22 (all or portions thereof) via the network controller 24. In some embodiments, the system 10 may also include a graphics processor 26 (e.g., graphics processing unit/GPU) and an AI accelerator 27. In some embodiments, the system 10 may also include a perception subsystem 18 (e.g., including one or more sensors and/or cameras) and/or an actuation subsystem 19. In an embodiment, the system 10 may also include a vision processing unit (VPU), not shown.

The host processor 12 and the I/O subsystem 16 may be implemented together on a semiconductor die as a system on chip (SoC) 11, shown encased in a solid line. The SoC 11 may therefore operate as a computing apparatus for autonomous vehicle control. In some embodiments, the SoC 11 may also include one or more of the system memory 20, the network controller 24, the graphics processor 26 and/or the AI accelerator 27 (shown encased in dotted lines). In some embodiments, SoC 11 may also include other components of system 10.

The host processor 12, the I/O subsystem 16, the graphics processor 26, the Al accelerator 27 and/or the VPU may execute program instructions 28 retrieved from the system memory 20 and/or the storage 22 to perform one or more aspects of process 600 as described herein with reference to FIG. 6. Thus, execution of instructions 28 may cause the SoC 11 to generate a series of time-stamped object graphs based on object trajectory histories derived from external object data for a plurality of external objects, generate, via a first neural network, a series of relational object representations based on the series of time-stamped object graphs, and determine, via a second neural network, predicted object trajectories for the plurality of external objects based on the series of relational object representations. The system 10 may implement one or more aspects of the autonomous vehicle system 100, the relational reasoning system 200, the graph extraction module 310, the graph attention network 410, and/or the LSTM network 510 as described herein with reference to FIGS. 1-5. The system 10 is therefore considered to be performance-enhanced at least to the extent that vehicle and object trajectories may be predicted based on local driving norms.

Computer program code to carry out the processes described above may be written in any combination of one or more programming languages, including an object-oriented programming language such as JAVA, JAVASCRIPT, PYTHON, SMALLTALK, C++ or the like and/or conventional procedural programming languages, such as the “C” programming language or similar programming languages, and implemented as program instructions 28. Additionally, program instructions 28 may include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, microprocessor, etc.).

The I/O devices 17 may include one or more of input devices, such as a touch-screen, keyboard, mouse, cursor-control device, touch-screen, microphone, digital camera, video recorder, camcorder, biometric scanners and/or sensors; input devices may be used to enter information and interact with system 10 and/or with other devices. The I/O devices 17 may also include one or more of output devices, such as a display (e.g., touch screen, liquid crystal display/LCD, light emitting diode/LED display, plasma panels, etc.), speakers and/or other visual or audio output devices. Input and/or output devices may be used, e.g., to provide a user interface.

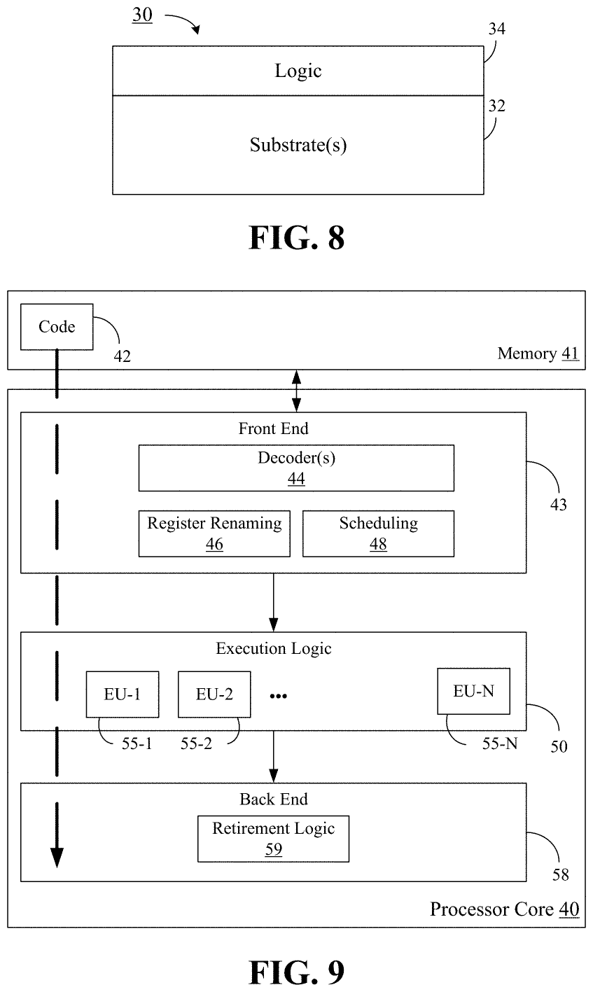

FIG. 8 shows a block diagram illustrating an example semiconductor apparatus 30 for predicting vehicle trajectories based on local driving norms according to one or more embodiments, with reference to components and features described herein including but not limited to the figures and associated description. The semiconductor apparatus 30 may be implemented, e.g., as a chip, die, or other semiconductor package. The semiconductor apparatus 30 may include one or more substrates 32 comprised of, e.g., silicon, sapphire, gallium arsenide, etc. The semiconductor apparatus 30 may also include logic 34 comprised of, e.g., transistor array(s) and other integrated circuit (IC) components) coupled to the substrate(s) 32. The logic 34 may be implemented at least partly in configurable logic or fixed-functionality logic hardware. The logic 34 may implement system on chip (SoC) 11 described above with reference to FIG. 7. The logic 34 may implement one or more aspects of process 600 as described herein with reference to FIG. 6, including generate a series of time-stamped object graphs based on object trajectory histories derived from external object data for a plurality of external objects, generate, via a first neural network, a series of relational object representations based on the series of time-stamped object graphs, and determine, via a second neural network, predicted object trajectories for the plurality of external objects based on the series of relational object representations. The logic 34 may implement one or more aspects of the autonomous vehicle system 100, the relational reasoning system 200, the graph extraction module 310, the graph attention network 410, and/or the LSTM network 510 as described herein with reference to FIGS. 1-5. The apparatus 30 is therefore considered to be performance-enhanced at least to the extent that vehicle and object trajectories may be predicted based on local driving norms.

The semiconductor apparatus 30 may be constructed using any appropriate semiconductor manufacturing processes or techniques. For example, the logic 34 may include transistor channel regions that are positioned (e.g., embedded) within the substrate(s) 32. Thus, the interface between the logic 34 and the substrate(s) 32 may not be an abrupt junction. The logic 34 may also be considered to include an epitaxial layer that is grown on an initial wafer of the substrate(s) 34.

FIG. 9 is a block diagram illustrating an example processor core 40 according to one or more embodiments, with reference to components and features described herein including but not limited to the figures and associated description. The processor core 40 may be the core for any type of processor, such as a micro-processor, an embedded processor, a digital signal processor (DSP), a network processor, or other device to execute code. Although only one processor core 40 is illustrated in FIG. 9, a processing element may alternatively include more than one of the processor core 40 illustrated in FIG. 9. The processor core 40 may be a single-threaded core or, for at least one embodiment, the processor core 40 may be multithreaded in that it may include more than one hardware thread context (or “logical processor”) per core.

FIG. 9 also illustrates a memory 41 coupled to processor core 40. The memory 41 may be any of a wide variety of memories (including various layers of memory hierarchy) as are known or otherwise available to those of skill in the art. The memory 41 may include one or more code 42 instruction(s) to be executed by the processor core 40. The code 42 may implement one or more aspects of the process 600 as described herein with reference to FIG. 6. The processor core 40 may implement one or more aspects of the autonomous vehicle system 100, the relational reasoning system 200, the graph extraction module 310, the graph attention network 410, and/or the LSTM network 510 as described herein with reference to FIGS. 1-5. The processor core 40 follows a program sequence of instructions indicated by the code 42. Each instruction may enter a front end portion 43 and be processed by one or more decoders 44. The decoder 44 may generate as its output a micro operation such as a fixed width micro operation in a predefined format, or may generate other instructions, microinstructions, or control signals which reflect the original code instruction. The illustrated front end portion 43 also includes register renaming logic 46 and scheduling logic 48, which generally allocate resources and queue the operation corresponding to the convert instruction for execution.

The processor core 40 is shown including execution logic 50 having a set of execution units 55-1 through 55-N. Some embodiments may include a number of execution units dedicated to specific functions or sets of functions. Other embodiments may include only one execution unit or one execution unit that can perform a particular function. The illustrated execution logic 50 performs the operations specified by code instructions.

After completion of execution of the operations specified by the code instructions, back end logic 58 retires the instructions of the code 42. In one embodiment, the processor core 40 allows out of order execution but requires in order retirement of instructions. The retirement logic 59 may take a variety of forms as known to those of skill in the art (e.g., re-order buffers or the like). In this manner, the processor core 40 is transformed during execution of the code 42, at least in terms of the output generated by the decoder, the hardware registers and tables utilized by the register renaming logic 46, and any registers (not shown) modified by the execution logic 50.

Although not illustrated in FIG. 9, a processing element may include other elements on chip with the processor core 40. For example, a processing element may include memory control logic along with the processor core 40. The processing element may include I/O control logic and/or may include I/O control logic integrated with memory control logic. The processing element may also include one or more caches.

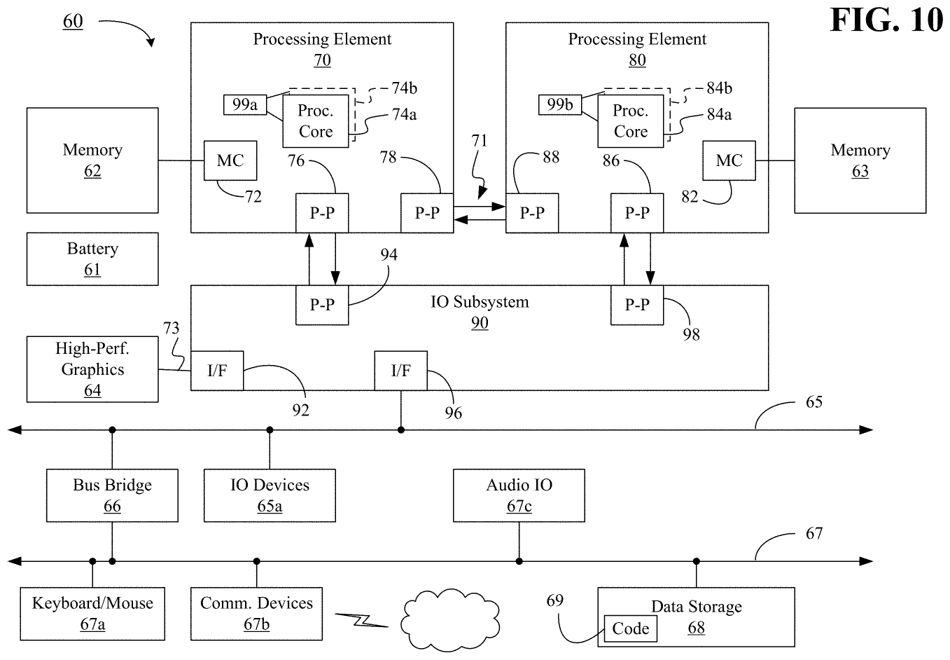

FIG. 10 is a block diagram illustrating an example of a multi-processor based computing system 60 according to one or more embodiments, with reference to components and features described herein including but not limited to the figures and associated description. The multiprocessor system 60 includes a first processing element 70 and a second processing element 80. While two processing elements 70 and 80 are shown, it is to be understood that an embodiment of the system 60 may also include only one such processing element.

The system 60 is illustrated as a point-to-point interconnect system, wherein the first processing element 70 and the second processing element 80 are coupled via a point-to-point interconnect 71. It should be understood that any or all of the interconnects illustrated in FIG. 10 may be implemented as a multi-drop bus rather than point-to-point interconnect.

As shown in FIG. 10, each of processing elements 70 and 80 may be multicore processors, including first and second processor cores (i.e., processor cores 74a and 74b and processor cores 84a and 84b). Such cores 74a, 74b, 84a, 84b may be configured to execute instruction code in a manner similar to that discussed above in connection with FIG. 9.

Each processing element 70, 80 may include at least one shared cache 99a, 99b. The shared cache 99a, 99b may store data (e.g., instructions) that are utilized by one or more components of the processor, such as the cores 74a, 74b and 84a, 84b, respectively. For example, the shared cache 99a, 99b may locally cache data stored in a memory 62, 63 for faster access by components of the processor. In one or more embodiments, the shared cache 99a, 99b may include one or more mid-level caches, such as level 2 (L2), level 3 (L3), level 4 (L4), or other levels of cache, a last level cache (LLC), and/or combinations thereof.

While shown with only two processing elements 70, 80, it is to be understood that the scope of the embodiments are not so limited. In other embodiments, one or more additional processing elements may be present in a given processor. Alternatively, one or more of processing elements 70, 80 may be an element other than a processor, such as an accelerator or a field programmable gate array. For example, additional processing element(s) may include additional processors(s) that are the same as a first processor 70, additional processor(s) that are heterogeneous or asymmetric to processor a first processor 70, accelerators (such as, e.g., graphics accelerators or digital signal processing (DSP) units), field programmable gate arrays, or any other processing element. There can be a variety of differences between the processing elements 70, 80 in terms of a spectrum of metrics of merit including architectural, micro architectural, thermal, power consumption characteristics, and the like. These differences may effectively manifest themselves as asymmetry and heterogeneity amongst the processing elements 70, 80. For at least one embodiment, the various processing elements 70, 80 may reside in the same die package.

The first processing element 70 may further include memory controller logic (MC) 72 and point-to-point (P-P) interfaces 76 and 78. Similarly, the second processing element 80 may include a MC 82 and P-P interfaces 86 and 88. As shown in FIG. 10, the MC's 72 and 82 couple the processors to respective memories, namely a memory 62 and a memory 63, which may be portions of main memory locally attached to the respective processors. While the MC 72 and 82 is illustrated as integrated into the processing elements 70, 80, for alternative embodiments the MC logic may be discrete logic outside the processing elements 70, 80 rather than integrated therein.

The first processing element 70 and the second processing element 80 may be coupled to an I/O subsystem 90 via P-P interconnects 76 and 86, respectively. As shown in FIG. 10, the I/O subsystem 90 includes P-P interfaces 94 and 98. Furthermore, the I/O subsystem 90 includes an interface 92 to couple the I/O subsystem 90 with a high performance graphics engine 64. In one embodiment, bus 73 may be used to couple the graphics engine 64 to the I/O subsystem 90. Alternately, a point-to-point interconnect may couple these components.

In turn, the I/O subsystem 90 may be coupled to a first bus 65 via an interface 96. In one embodiment, the first bus 65 may be a Peripheral Component Interconnect (PCI) bus, or a bus such as a PCI Express bus or another third generation I/O interconnect bus, although the scope of the embodiments are not so limited.

As shown in FIG. 10, various I/O devices 65a (e.g., biometric scanners, speakers, cameras, sensors) may be coupled to the first bus 65, along with a bus bridge 66 which may couple the first bus 65 to a second bus 67. In one embodiment, the second bus 67 may be a low pin count (LPC) bus. Various devices may be coupled to the second bus 67 including, for example, a keyboard/mouse 67a, communication device(s) 67b, and a data storage unit 68 such as a disk drive or other mass storage device which may include code 69, in one embodiment. The illustrated code 69 may implement one or more aspects of the process 600 as described herein with reference to FIG. 6. The illustrated code 69 may be similar to code 42 (FIG. 9), already discussed. Further, an audio I/O 67c may be coupled to second bus 67 and a battery 61 may supply power to the computing system 60. The system 60 may implement one or more aspects of the autonomous vehicle system 100, the relational reasoning system 200, the graph extraction module 310, the graph attention network 410, and/or the LSTM network 510 as described herein with reference to FIGS. 1-5.

Note that other embodiments are contemplated. For example, instead of the point-to-point architecture of FIG. 10, a system may implement a multi-drop bus or another such communication topology. Also, the elements of FIG. 10 may alternatively be partitioned using more or fewer integrated chips than shown in FIG. 10.

Embodiments of each of the above systems, devices, components and/or methods, including the system 10, the semiconductor apparatus 30, the processor core 40, the system 60, the autonomous vehicle system 100, the relational reasoning system 200, the graph extraction module 310, the graph attention network 410, the LSTM network 510, and/or the process 600, and/or any other system components, may be implemented in hardware, software, or any suitable combination thereof. For example, hardware implementations may include configurable logic such as, for example, programmable logic arrays (PLAs), field programmable gate arrays (FPGAs), complex programmable logic devices (CPLDs), or fixed-functionality logic hardware using circuit technology such as, for example, application specific integrated circuit (ASIC), complementary metal oxide semiconductor (CMOS) or transistor-transistor logic (TTL) technology, or any combination thereof.

Alternatively, or additionally, all or portions of the foregoing systems and/or components and/or methods may be implemented in one or more modules as a set of logic instructions stored in a machine- or computer-readable storage medium such as random access memory (RAM), read only memory (ROM), programmable ROM (PROM), firmware, flash memory, etc., to be executed by a processor or computing device. For example, computer program code to carry out the operations of the components may be written in any combination of one or more operating system (OS) applicable/appropriate programming languages, including an object-oriented programming language such as PYTHON, PERL, JAVA, SMALLTALK, C++, C# or the like and conventional procedural programming languages, such as the “C” programming language or similar programming languages.

### Additional Notes and Examples

Example 1 includes a computing system comprising a sensor interface to receive external object data, a processor coupled to the sensor interface, the processor including one or more substrates and logic coupled to the one or more substrates, wherein the logic is implemented at least partly in one or more of configurable logic or fixed-functionality hardware logic, the logic coupled to the one or more substrates to generate a series of time-stamped object graphs based on object trajectory histories derived from the external object data for a plurality of external objects, generate, via a first neural network, a series of relational object representations based on the series of time-stamped object graphs, and determine, via a second neural network, a prediction of future object trajectories for the plurality of external objects based on the series of relational object representations.

Example 2 includes the system of Example 1, wherein the logic coupled to the one or more substrates is further to include real-time perceptual error information with the predicted object trajectories, and modify behavior of an autonomous vehicle based on the predicted object trajectories and the real-time perceptual error information.

Example 3 includes the system of Example 1, wherein the logic coupled to the one or more substrates is further to determine deviation of observed object behaviors from predicted object behaviors, and modify behavior of an autonomous vehicle based on the determined object behavioral deviation.

Example 4 includes the system of Example 1, wherein the object trajectory histories include coordinates for a plurality of vehicles within a time window, wherein the series of time-stamped object graphs assist learning how the vehicles relate over the time window, wherein the relational object representations represent learned relationships among the plurality of vehicles over the time window, and wherein the first neural network is to encode location-based driving norms.

Example 5 includes the system of Example 4, wherein the second neural network comprises a first recurrent neural network that is to encode temporal vehicle location changes and a second recurrent neural network that is to predict future behaviors for the plurality of vehicles.

Example 6 includes the system of any of Examples 1-5, wherein the first neural network comprises a graph attention (GAT) network and the second neural network comprises a long short-term memory (LSTM) network, and wherein the first neural network and the second neural network are trained as a unit using object trajectory histories generated from relational object data obtained from vehicle driving data collected across a plurality of geographic locations.

Example 7 includes a semiconductor apparatus comprising one or more substrates, and logic coupled to the one or more substrates, wherein the logic is implemented at least partly in one or more of configurable logic or fixed-functionality hardware logic, the logic coupled to the one or more substrates to generate a series of time-stamped object graphs based on object trajectory histories derived from external object data for a plurality of external objects, generate, via a first neural network, a series of relational object representations based on the series of time-stamped object graphs, and determine, via a second neural network, a prediction of future object trajectories for the plurality of external objects based on the series of relational object representations.

Example 8 includes the semiconductor apparatus of Example 7, wherein the logic coupled to the one or more substrates is further to include real-time perceptual error information with the predicted object trajectories, and modify behavior of an autonomous vehicle based on the predicted object trajectories and the real-time perceptual error information.

Example 9 includes the semiconductor apparatus of Example 7, wherein the logic coupled to the one or more substrates is further to determine deviation of observed object behaviors from predicted object behaviors, and modify behavior of an autonomous vehicle based on the determined object behavioral deviation.

Example 10 includes the semiconductor apparatus of Example 7, wherein the object trajectory histories include coordinates for a plurality of vehicles within a time window, wherein the series of time-stamped object graphs assist learning how the vehicles relate over the time window, wherein the relational object representations represent learned relationships among the plurality of vehicles over the time window, and wherein the first neural network is to encode location-based driving norms.

Example 11 includes the semiconductor apparatus of Example 10, wherein the second neural network comprises a first recurrent neural network that is to encode temporal vehicle location changes and a second recurrent neural network that is to predict future behaviors for the plurality of vehicles.

Example 12 includes the semiconductor apparatus of any of Examples 7-11, wherein the first neural network comprises a graph attention (GAT) network and the second neural network comprises a long short-term memory (LSTM) network, and wherein the first neural network and the second neural network are trained as a unit using object trajectory histories generated from relational object data obtained from vehicle driving data collected across a plurality of geographic locations.

Example 13 includes the semiconductor apparatus of Example 7, wherein the logic coupled to the one or more substrates includes transistor channel regions that are positioned within the one or more substrates.

Example 14 includes at least one non-transitory computer readable storage medium comprising a set of instructions which, when executed by a computing system, cause the computing system to generate a series of time-stamped object graphs based on object trajectory histories derived from external object data for a plurality of external objects, generate, via a first neural network, a series of relational object representations based on the series of time-stamped object graphs, and determine, via a second neural network, a prediction of future object trajectories for the plurality of external objects based on the series of relational object representations.

Example 15 includes the at least one non-transitory computer readable storage medium of Example 14, wherein the instructions, when executed, further cause the computing system to include real-time perceptual error information with the predicted object trajectories, and modify behavior of an autonomous vehicle based on the predicted object trajectories and the real-time perceptual error information.

Example 16 includes the at least one non-transitory computer readable storage medium of Example 14, wherein the instructions, when executed, further cause the computing system to determine deviation of observed object behaviors from predicted object behaviors, and modify behavior of an autonomous vehicle based on the determined object behavioral deviation.

Example 17 includes the at least one non-transitory computer readable storage medium of Example 14, wherein the object trajectory histories include coordinates for a plurality of vehicles within a time window, wherein the series of time-stamped object graphs assist learning how the vehicles relate over the time window, wherein the relational object representations represent learned relationships among the plurality of vehicles over the time window, and wherein the first neural network is to encode location-based driving norms.

Example 18 includes the at least one non-transitory computer readable storage medium of Example 17, wherein the second neural network comprises a first recurrent neural network that is to encode temporal vehicle location changes and a second recurrent neural network that is to predict future behaviors for the plurality of vehicles.

Example 19 includes the at least one non-transitory computer readable storage medium of any of Examples 14-18, wherein the first neural network comprises a graph attention (GAT) network and the second neural network comprises a long short-term memory (LSTM) network, and wherein the first neural network and the second neural network are trained as a unit using object trajectory histories generated from relational object data obtained from vehicle driving data collected across a plurality of geographic locations.

Example 20 includes a relational reasoning method comprising generating a series of time-stamped object graphs based on object trajectory histories derived from external object data for a plurality of external objects, generating, via a first neural network, a series of relational object representations based on the series of time-stamped object graphs, and determining, via a second neural network, a prediction of future object trajectories for the plurality of external objects based on the series of relational object representations.

Example 21 includes the method of Example 20, further comprising including real-time perceptual error information with the predicted object trajectories, and modifying behavior of an autonomous vehicle based on the predicted object trajectories and the real-time perceptual error information.

Example 22 includes the method of Example 20, further comprising determining deviation of observed object behaviors from predicted object behaviors, and modifying behavior of an autonomous vehicle based on the determined object behavioral deviation.

Example 23 includes the method of Example 20, wherein the object trajectory histories include coordinates for a plurality of vehicles within a time window, wherein the series of time-stamped object graphs assist learning how the vehicles relate over the time window, wherein the relational object representations represent learned relationships among the plurality of vehicles over the time window, and wherein the first neural network encodes location-based driving norms.

Example 24 includes the method of Example 23, wherein the second neural network comprises a first recurrent neural network that encodes temporal vehicle location changes and a second recurrent neural network that predicts future behaviors for the plurality of vehicles.

Example 25 includes the method of any of Examples 20-24, wherein the first neural network comprises a graph attention (GAT) network and the second neural network comprises a long short-term memory (LSTM) network, and wherein the first neural network and the second neural network are trained as a unit using object trajectory histories generated from relational object data obtained from vehicle driving data collected across a plurality of geographic locations.

Example 26 includes an apparatus comprising means for performing the method of any of Examples 20-24.

Thus, technology described herein provides for efficient and robust prediction of future trajectories for an autonomous vehicle as well as for neighboring vehicles and objects by generalizing social driving norms and other types of relational information. The technology prioritizes actions and responses based on relational cues from the driving environment including geo-spatial information about standard driving norms. Additionally, the technology enables navigating the vehicle based on predicted object trajectories and real-time perceptual error information, and modifying safety criteria based on deviation of object behavior from predicted behavior.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a sensor interface to receive external object data; and
a processor coupled to the sensor interface, the processor including one or more substrates and logic coupled to the one or more substrates, wherein the logic is implemented at least partly in one or more of configurable logic or fixed-functionality hardware logic, the logic coupled to the one or more substrates to:
generate a series of time-stamped object graphs based on object trajectory histories derived from the external object data for a plurality of external objects;
generate, via a first neural network, a series of relational object representations based on the series of time-stamped object graphs; and
determine, via a second neural network, a prediction of future object trajectories for the plurality of external objects based on the series of relational object representations.

2. The system of claim 1, wherein the logic coupled to the one or more substrates is further to:
include real-time perceptual error information with the predicted object trajectories; and
modify behavior of an autonomous vehicle based on the predicted object trajectories and the real-time perceptual error information.

3. The system of claim 1, wherein the logic coupled to the one or more substrates is further to:
determine deviation of observed object behaviors from predicted object behaviors; and
modify behavior of an autonomous vehicle based on the determined object behavioral deviation.

4. The system of claim 1, wherein the object trajectory histories include coordinates for a plurality of vehicles within a time window, wherein the series of time-stamped object graphs assist learning how the vehicles relate over the time window, wherein the relational object representations represent learned relationships among the plurality of vehicles over the time window, and wherein the first neural network is to encode location-based driving norms.

5. The system of claim 4, wherein the second neural network comprises a first recurrent neural network that is to encode temporal vehicle location changes and a second recurrent neural network that is to predict future behaviors for the plurality of vehicles.

6. The system of claim 5, wherein the first neural network comprises a graph attention (GAT) network and the second neural network comprises a long short-term memory (LSTM) network, and wherein the first neural network and the second neural network are trained as a unit using object trajectory histories generated from relational object data obtained from vehicle driving data collected across a plurality of geographic locations.

7. A semiconductor apparatus comprising:
one or more substrates; and
logic coupled to the one or more substrates, wherein the logic is implemented at least partly in one or more of configurable logic or fixed-functionality hardware logic, the logic coupled to the one or more substrates to:
generate a series of time-stamped object graphs based on object trajectory histories derived from external object data for a plurality of external objects;
generate, via a first neural network, a series of relational object representations based on the series of time-stamped object graphs; and
determine, via a second neural network, a prediction of future object trajectories for the plurality of external objects based on the series of relational object representations.

8. The semiconductor apparatus of claim 7, wherein the logic coupled to the one or more substrates is further to:
include real-time perceptual error information with the predicted object trajectories; and
modify behavior of an autonomous vehicle based on the predicted object trajectories and the real-time perceptual error information.

9. The semiconductor apparatus of claim 7, wherein the logic coupled to the one or more substrates is further to:
determine deviation of observed object behaviors from predicted object behaviors; and
modify behavior of an autonomous vehicle based on the determined object behavioral deviation.

10. The semiconductor apparatus of claim 7, wherein the object trajectory histories include coordinates for a plurality of vehicles within a time window, wherein the series of time-stamped object graphs assist learning how the vehicles relate over the time window, wherein the relational object representations represent learned relationships among the plurality of vehicles over the time window, and wherein the first neural network is to encode location-based driving norms.

11. The semiconductor apparatus of claim 10, wherein the second neural network comprises a first recurrent neural network that is to encode temporal vehicle location changes and a second recurrent neural network that is to predict future behaviors for the plurality of vehicles.

12. The semiconductor apparatus of claim 11, wherein the first neural network comprises a graph attention (GAT) network and the second neural network comprises a long short-term memory (LSTM) network, and wherein the first neural network and the second neural network are trained as a unit using object trajectory histories generated from relational object data obtained from vehicle driving data collected across a plurality of geographic locations.

13. The semiconductor apparatus of claim 7, wherein the logic coupled to the one or more substrates includes transistor channel regions that are positioned within the one or more substrates.

14. At least one non-transitory computer readable storage medium comprising a set of instructions which, when executed by a computing system, cause the computing system to:
generate a series of time-stamped object graphs based on object trajectory histories derived from external object data for a plurality of external objects;
generate, via a first neural network, a series of relational object representations based on the series of time-stamped object graphs; and
determine, via a second neural network, a prediction of future object trajectories for the plurality of external objects based on the series of relational object representations.

15. The at least one non-transitory computer readable storage medium of claim 14, wherein the instructions, when executed, further cause the computing system to:
include real-time perceptual error information with the predicted object trajectories; and
modify behavior of an autonomous vehicle based on the predicted object trajectories and the real-time perceptual error information.

16. The at least one non-transitory computer readable storage medium of claim 14, wherein the instructions, when executed, further cause the computing system to:
determine deviation of observed object behaviors from predicted object behaviors; and
modify behavior of an autonomous vehicle based on the determined object behavioral deviation.

17. The at least one non-transitory computer readable storage medium of claim 14, wherein the object trajectory histories include coordinates for a plurality of vehicles within a time window, wherein the series of time-stamped object graphs assist learning how the vehicles relate over the time window, wherein the relational object representations represent learned relationships among the plurality of vehicles over the time window, and wherein the first neural network is to encode location-based driving norms.

18. The at least one non-transitory computer readable storage medium of claim 17, wherein the second neural network comprises a first recurrent neural network that is to encode temporal vehicle location changes and a second recurrent neural network that is to predict future behaviors for the plurality of vehicles.

19. The at least one non-transitory computer readable storage medium of claim 18, wherein the first neural network comprises a graph attention (GAT) network and the second neural network comprises a long short-term memory (LSTM) network, and wherein the first neural network and the second neural network are trained as a unit using object trajectory histories generated from relational object data obtained from vehicle driving data collected across a plurality of geographic locations.

20. A relational reasoning method comprising:
generating a series of time-stamped object graphs based on object trajectory histories derived from external object data for a plurality of external objects;
generating, via a first neural network, a series of relational object representations based on the series of time-stamped object graphs; and
determining, via a second neural network, a prediction of future object trajectories for the plurality of external objects based on the series of relational object representations.

21. The method of claim 20, further comprising:
including real-time perceptual error information with the predicted object trajectories; and
modifying behavior of an autonomous vehicle based on the predicted object trajectories and the real-time perceptual error information.

22. The method of claim 20, further comprising:
determining deviation of observed object behaviors from predicted object behaviors; and
modifying behavior of an autonomous vehicle based on the determined object behavioral deviation.

23. The method of claim 20, wherein the object trajectory histories include coordinates for a plurality of vehicles within a time window, wherein the series of time-stamped object graphs assist learning how the vehicles relate over the time window, wherein the relational object representations represent learned relationships among the plurality of vehicles over the time window, and wherein the first neural network encodes location-based driving norms.

24. The method of claim 23, wherein the second neural network comprises a first recurrent neural network that encodes temporal vehicle location changes and a second recurrent neural network that predicts future behaviors for the plurality of vehicles.

25. The method of claim 24, wherein the first neural network comprises a graph attention (GAT) network and the second neural network comprises a long short-term memory (LSTM) network, and wherein the first neural network and the second neural network are trained as a unit using object trajectory histories generated from relational object data obtained from vehicle driving data collected across a plurality of geographic locations.
